(19) United States
(12) Patent Application Publication
(10) Pub. No.: US 2008/0049654 A1
(43) Pub. Date: Feb. 28, 2008

(54) Muliple Receiver Aggregation (Mra) with Different Data Rates for Ieee 802.11N

(75) Inventors: Begonya Otal, Barcelona (ES); Joerg Habetha, Aachen (DE); Francesc Dalmases, Bellaterra (ES); Pen C. Li, San Jose, CA (US); Monisha Ghosh, Chappaqua, NY (US); Parag Garg, Sunnyvale, CA (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,039

(22) PCT Filed: May 12, 2005
(86) PCT No.: PCT/IB05/51568

§ 371 Date: Aug. 27, 2007

Related U.S. Application Data
(60) Provisional application No. 60/570,638, filed on May 13, 2004.
(60) Provisional application No. 60/580,158, filed on Jun. 16, 2004.
(60) Provisional application No. 60/638,083, filed on Dec. 21, 2004.

(51) Int. Cl. H04L 12/28; H04L 29/06

(52) U.S. Cl. 370/311; 370/349; 370/468; 370/473

(57) ABSTRACT

Method, frame definitions (300 400 500 700 800 1000 1200 1300 1400) and system for transmission of an aggregation of packets which includes a plurality of Medium Access Control (MAC) Protocol Data Units (MPDUs) or PLCP (Physical Layer Convergence Protocol) Protocol Data Units (PPDUs) intended for one or several receivers and transmitted at one or several different Physical (PHY) rates. In some aspects of the invention, a pre-amble, rsp. mid-amble (415.i 515.i 715.i 815.i 1015.i 1215.i 1315.i) is transmitted in-between each or between multiples of MPDUs or PPDUs allowing receiver devices to go into sleep mode and wake-up during the aggregate or packet burst. Furthermore, information is transmitted at the beginning of the aggregate/packet burst, which allows devices to deduce the position of MPDUs/PPDUs or multiples of MPDUs/PPDUs in the aggregate. MPDUs or PPDUs are grouped in order to enable efficient sleep times of the receiving devices. The receiving devices decode the information at the beginning of the aggregate/burst, fall into sleep-mode and wake up shortly before their packets have to be received.

The present invention relates to apparatuses and processes designed for use with a form of data transmission using an aggregated data frame having a plurality of packets. More particularly, the present invention relates to multiple MCS (modulation and coding scheme) and receiver aggregation (MMRA) data transmission and power savings.

The Physical layer of current wireless systems, such as LANs that operate under access protocols known as IEEE 802.11, has several different options for modulation and coding. The selection of these options is normally determined by the maximum data rate given the packet error rate is smaller than a given threshold.

For example, the current Task Group N of IEEE Specification of 802.11 is developing a new Physical (PHY) and Medium Access Control (MAC) specifications for high data rate WLANs. Several industry consortia are currently preparing proposals for Task Group N, including the industry consortium TGn Sync. The current specification of TGn Sync does not allow for different data rates in multiple receiver aggregation (MRA). For example, the furthest receiver typically may have the slowest throughput, which can cause significant delays for other nodes/devices seeking to transmit or receive data, which in turn increases the drain on power. Especially, if packets intended for different receivers are aggregated into one aggregate or burst and have to be transmitted at the same MCS, some of the receivers experience a smaller data rate than they could actually support resulting in inefficient use of the medium. The reason is that a single rate aggregate has to be transmitted at a data rate that can still be decoded by the receiver with the worst radio link of all involved receivers. This data rate is in general much smaller than the data rate that receivers with a better radio link could still decode. These better radio links are therefore not optimally used by single rate aggregation schemes.

Another problem with state of the art packet aggregation schemes is that no power saving is possible during the aggregate. As aggregates can become very long, the stations have to stay awake for a long time, which drains battery power. The reason why no power saving is possible is that the receivers do either not know whether they will receive packets during the aggregate (and therefore have to stay awake in order to check each and every packet in the aggregate) or because they know that they will receive a packet but do not know at which position in the aggregate the packet will arrive. Even if the receivers knew the position of their packets in the aggregate, they could not go to sleep mode until the beginning of these packets, because they would loose synchronization with the time reference as well as with the channel state during their sleep phase.

Accordingly, there is a need in the art to provide packet aggregation to enable reception by different users at different PHY rates and to allow for efficient power saving at the receiving stations. However, this need must be addressed for proper consideration of Quality of Service (QoS) parameters that include not just bandwidth (throughput) but delay, delay jitter, packet loss rates and battery lifetime.

The presently claimed invention provides a method, system and an apparatus for providing a number of MAC Protocol Data Units MPDUs, to a group of different receivers. These MPDUs are either aggregated into a single PLCP (Physical Layer Convergence Protocol) Protocol Packet Data Unit (PPDU) or a burst of PPDUs. The scheme supports delivery of the individual MPDUs at different PHY rates with a potential of executing an efficient power saving scheme at the receiver device. A key feature of the invention is the announcement at the beginning of the aggregate, of the identifiers (like e.g. MAC addresses) of the intended receivers of the aggregate and the position of the MPDUs or PPDUs inside the aggregate. Furthermore, the different MCSs/data rates at which the MPDUs or PPDUs will be transmitted are also announced. Another key feature is the inclusion of pre-ambles or mid-ambles in-between MPDUs in order to allow receiving stations to go to sleep-mode and to re-synchronize and eventually re-assess the channel afterwards by means of the pre-/mid-ambles.

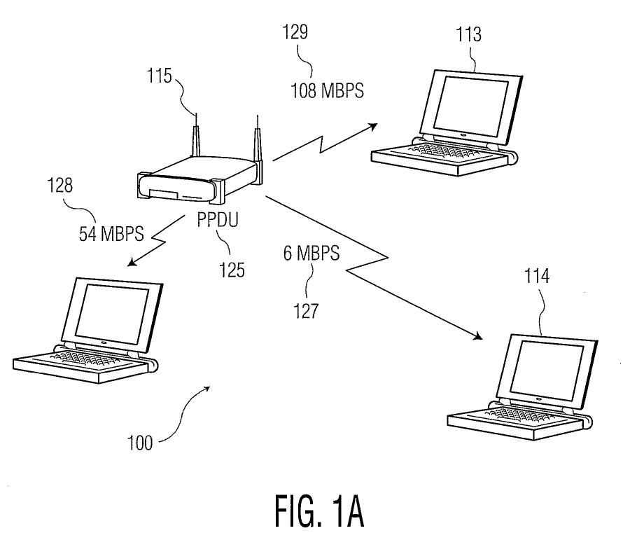

FIG. 1 illustrates a system having a plurality of devices and their different PHY transmission rates.

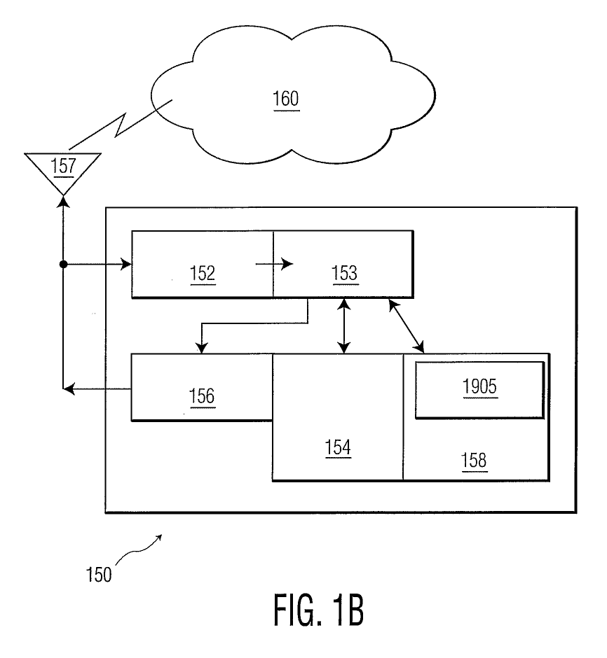

FIG. 2 illustrates a typical PPDU according to the prior art.

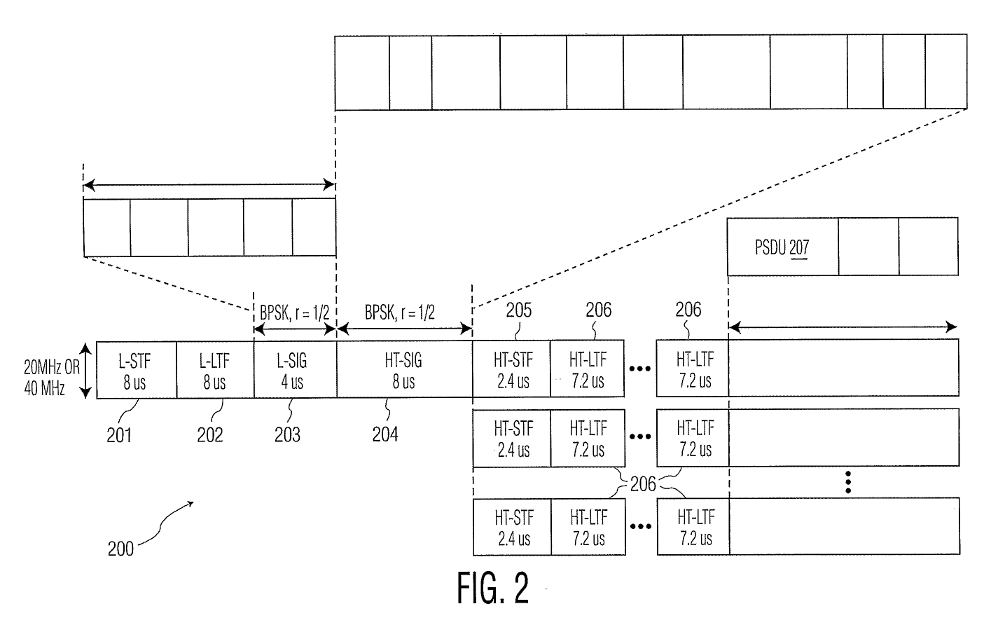

FIG. 3 illustrates how the exemplary PPDU is changed according to the present invention.

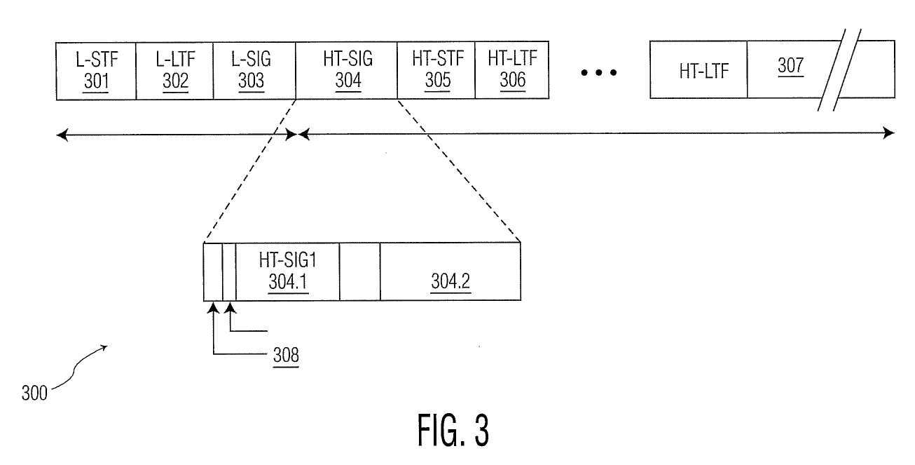

FIG. 4 illustrates a first variation of the structure of the aggregation information.

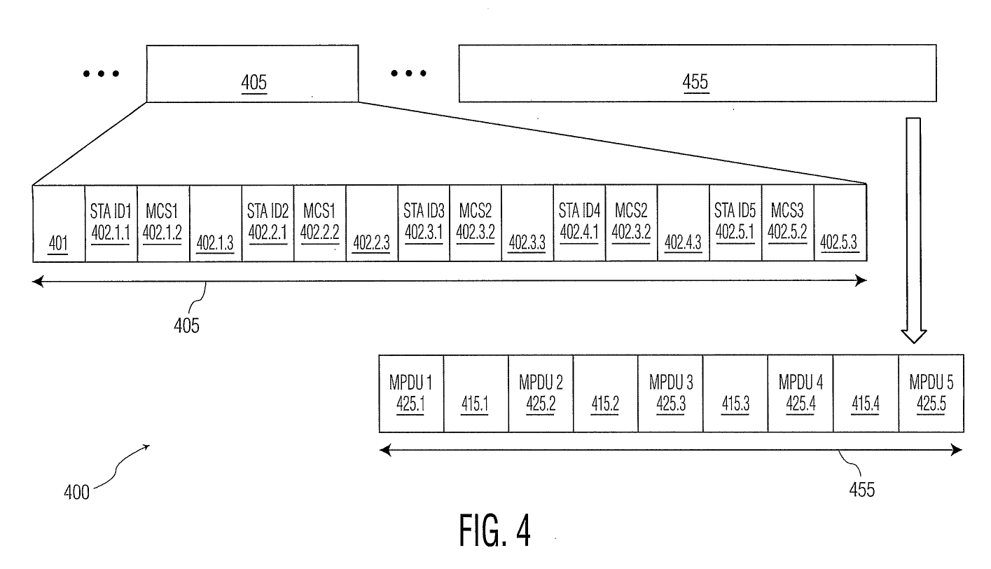

FIG. 5 illustrates a second variation of the structure of the aggregation information in accordance with another aspect of the invention.

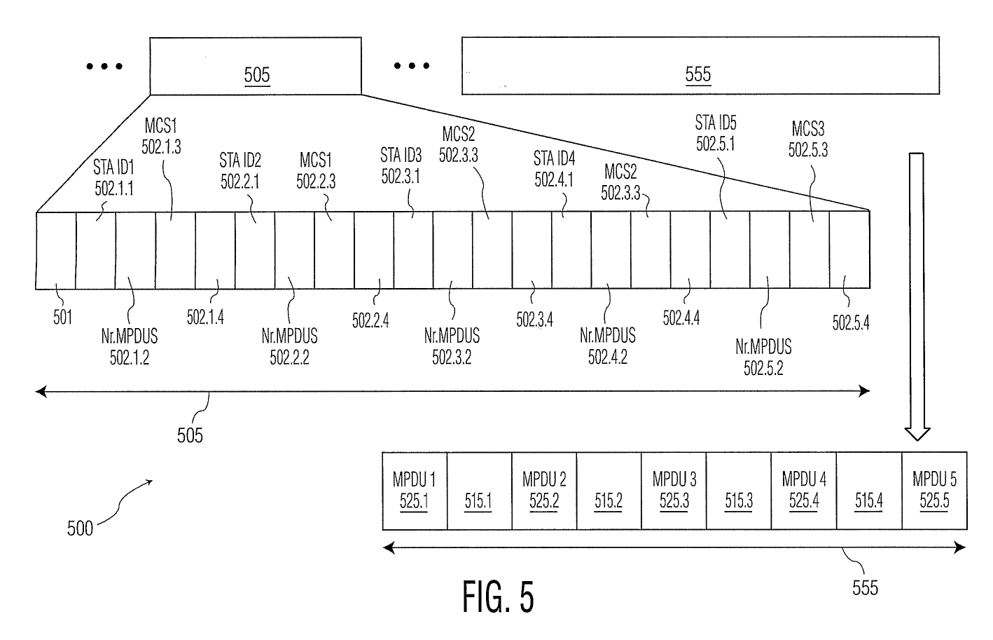

FIG. 6 illustrates active/sleep phases in accordance with the first and second variations of the aggregation structure shown in FIG. 4 and FIG. 5.

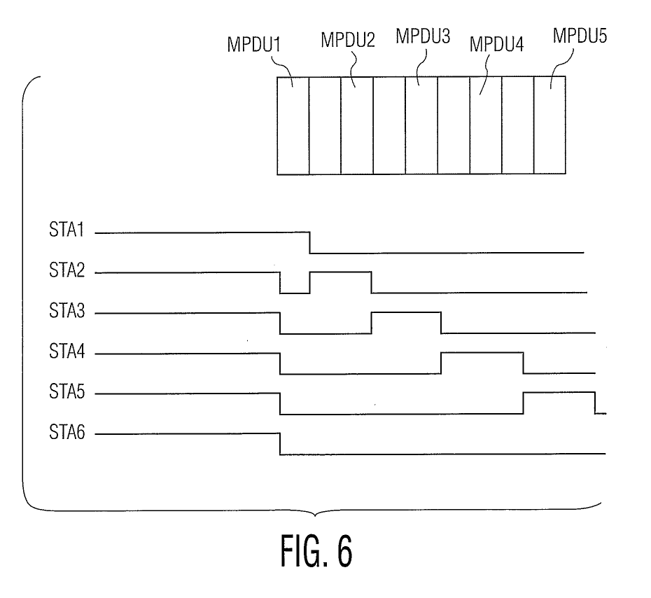

FIG. 7 illustrates a third variation of the structure of the aggregation information in accordance with another aspect of the invention.

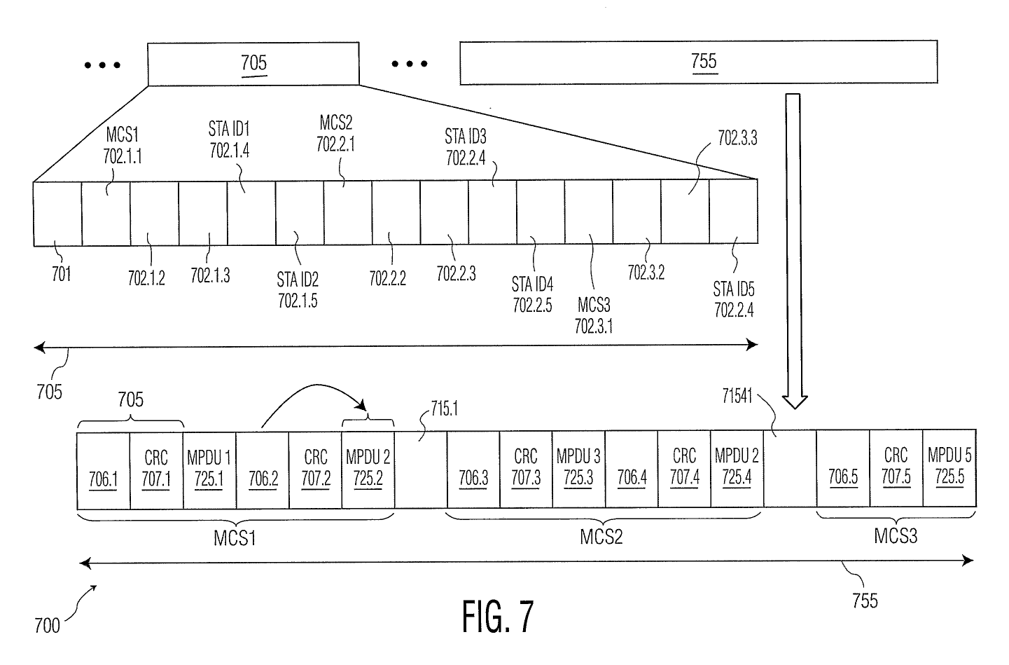

FIG. 8 illustrates a fourth variation of the structure of aggregation information in accordance with another aspect of the invention.

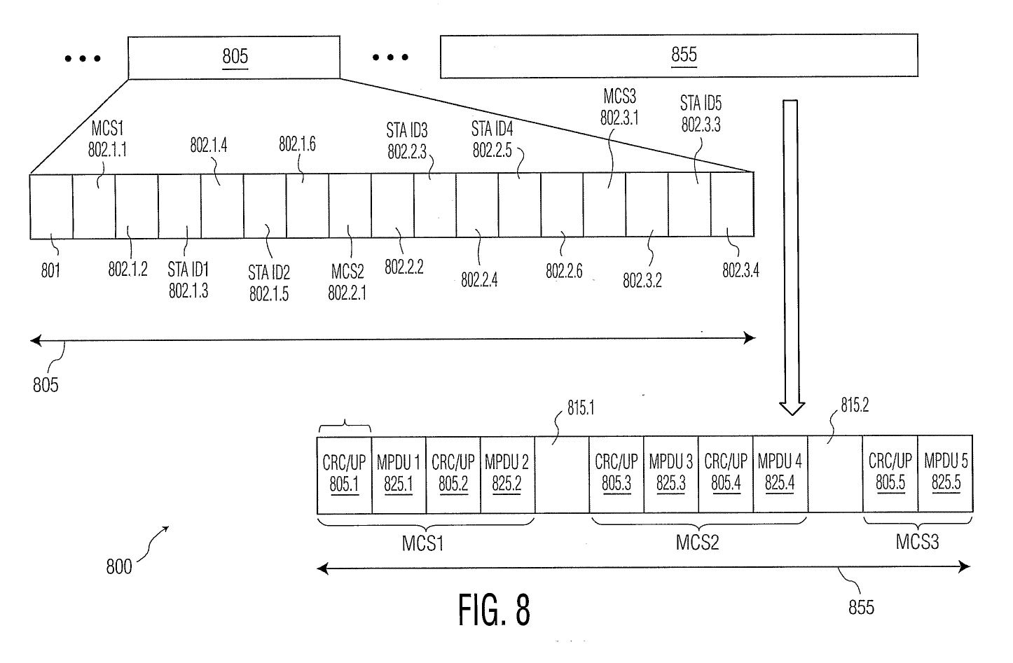

FIG. 9 illustrates active/sleep phases in accordance with the third and fourth variations of the aggregation information shown in FIG. 7 and FIG. 8.

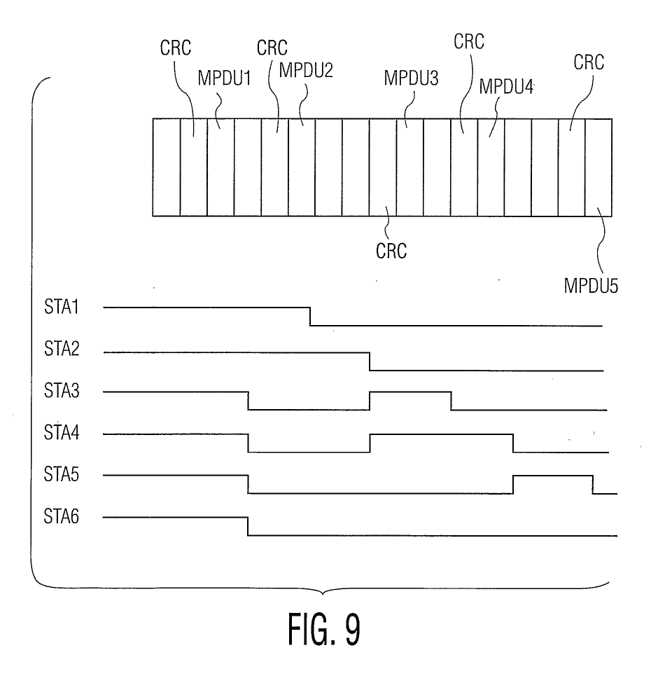

FIG. 10 illustrates a fifth variation of the structure of aggregation information in accordance with another aspect of the invention.

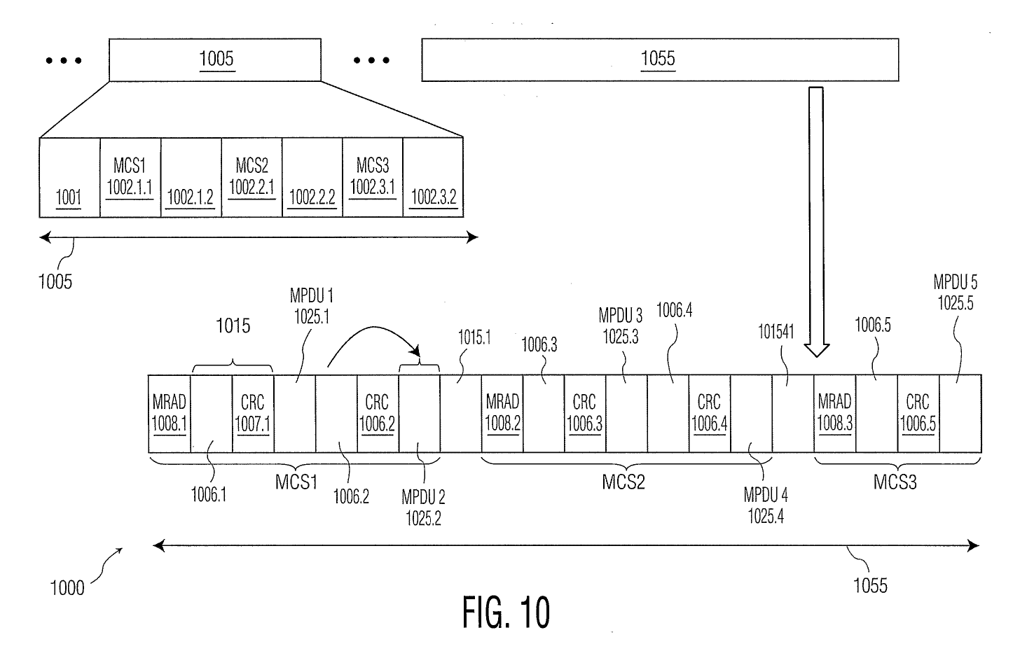

FIG. 11 illustrates active/sleep phases in accordance with the fifth variation of the aggregation information shown in FIG. 10.

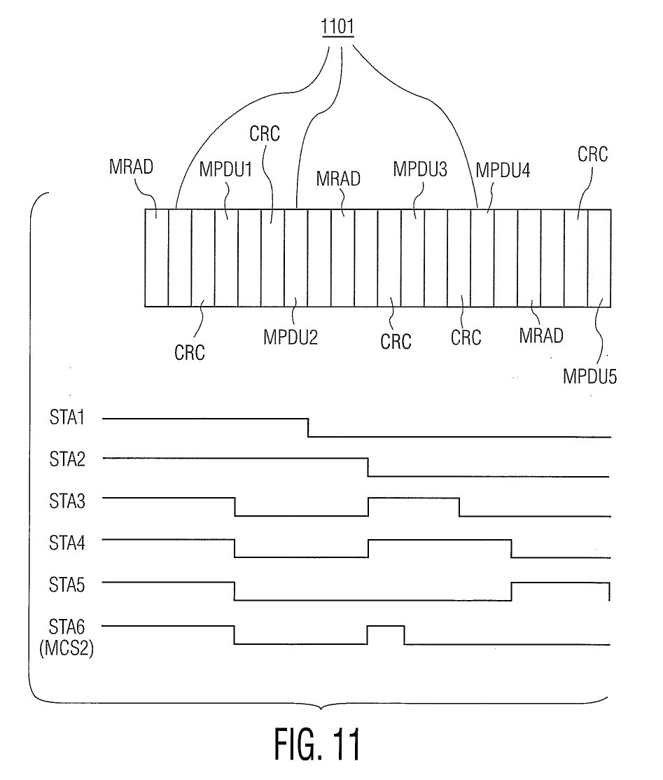

FIG. 12 illustrates a sixth variation of the structure of aggregation information in accordance with another aspect of the invention.

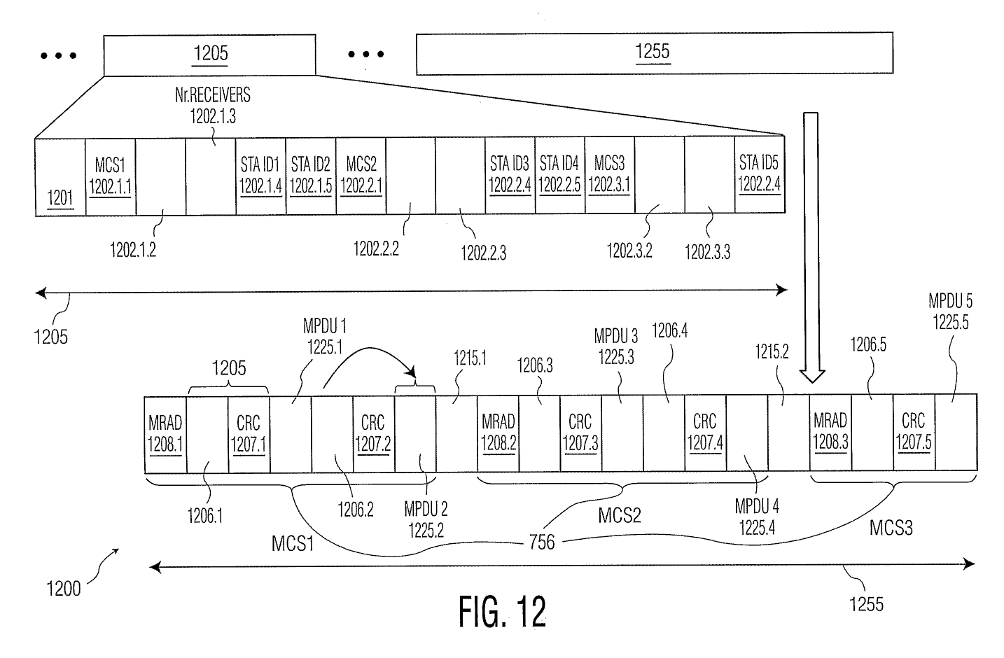

FIG. 13 illustrates a seventh variation of the structure of aggregation information in accordance with another aspect of the invention.

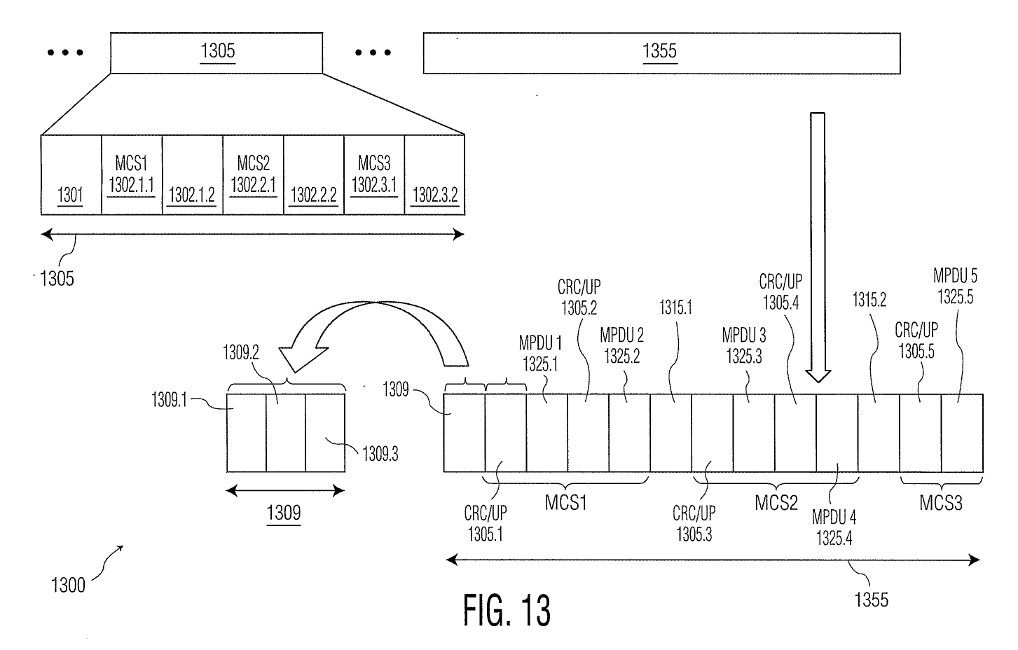

FIG. 14 illustrates an eighth variation of the structure of aggregation information in accordance with another aspect of the invention.

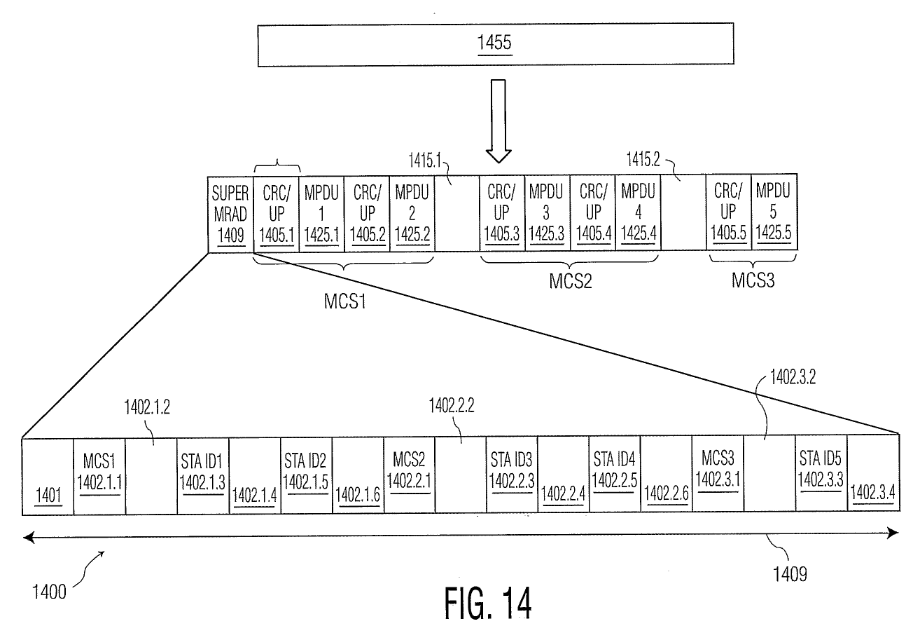

FIG. 15 illustrates active/sleep phases in accordance with the seventh and eighth variation of the aggregation information shown in FIG. 13 and FIG. 14.

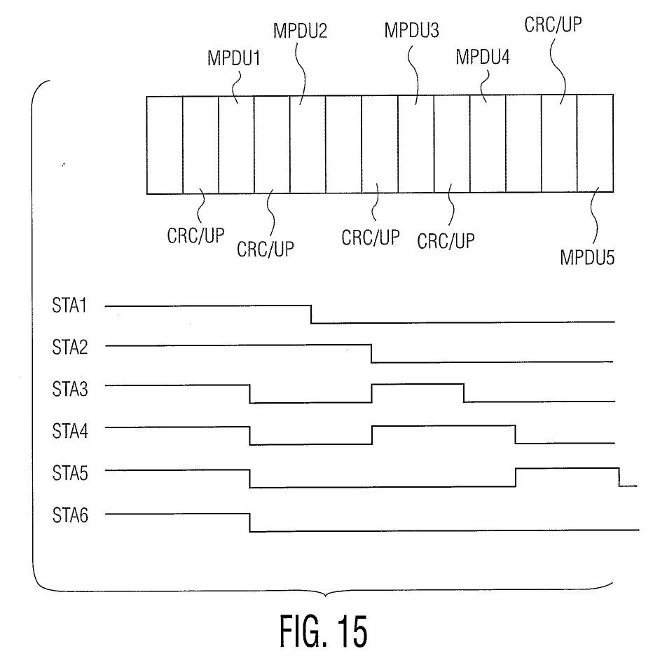

FIG. 16 illustrates a ninth variation of the structure of aggregation information in accordance with another aspect of the invention.

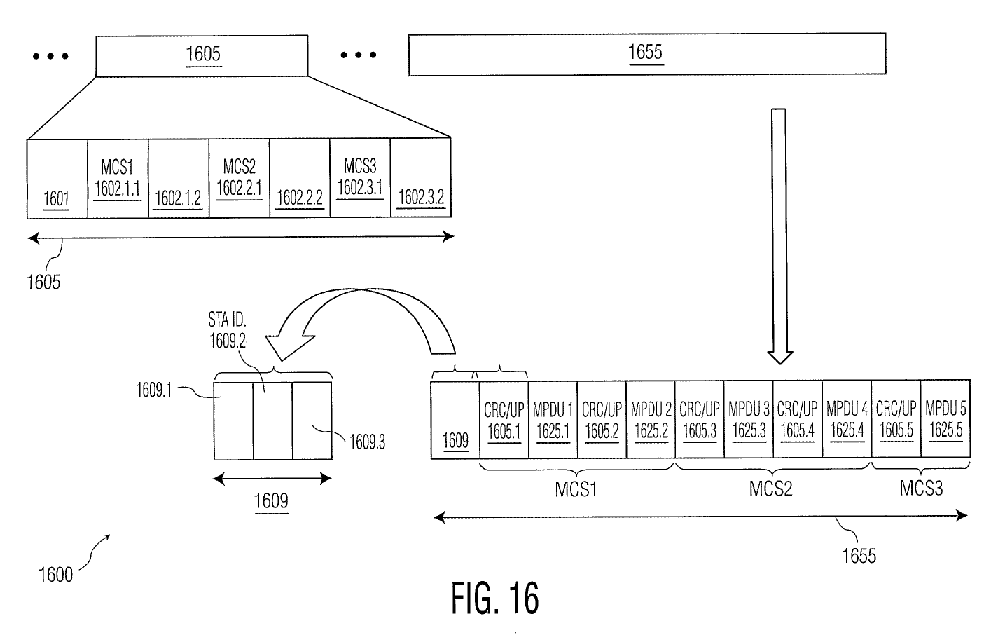

FIG. 17 illustrates active/sleep phases in accordance with the ninth variation of the aggregation information shown in FIG. 13 and FIG. 14.

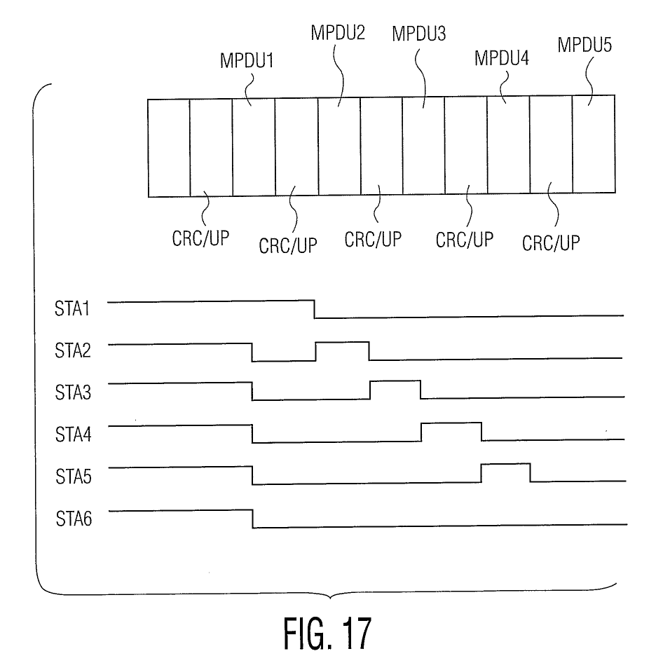

FIG. 18 illustrates how the structure of aggregation information could be transmitted in a burst of MPDUs or PPDUs.

It is to be understood by persons of ordinary skill in the art that the following descriptions are provided for purposes of illustration and not for limitation. An artisan understands that there are many variations that lie within the spirit of the invention and the scope of the appended claims. Unnecessary detail of known functions and operations may be omitted from the current description so as not to obscure the finer points of the present invention.

FIG. 1A illustrates one typical example of a system for transmission of multi-rate aggregated packets according to the present invention. Again, it is stressed that a typical system would be far more complex than shown and may include a plethora of different devices communicating in wired or wireless fashion. The system shown in FIG. 1A includes a plurality of nodes 112 113 114 and a device 115. At least one of the plurality of nodes is adapted for receiving a PPDU 125 comprising an aggregation of packets according to the present invention.

In addition, one node 114 of the plurality of nodes 112 113 114 may have a different PHY rate of transmission than the other nodes. It is also to be noted that at least one (typically more) of the plurality of nodes 112 113 114 are adapted for receiving the PPDU125 comprising an aggregation of packets at different transmission rates 127 128 129. Thus, a series of different nodes with different transmission rates can use the PPDU according to the present invention at rates that maximize their efficiency.

Moreover, it should be noted that at least one of the plurality of nodes 112 113 114 may comprise a legacy device 112 that transmits and receives non-aggregated packet frames according to medium access control (MAC) protocols.

One advantage of the multiple rate aggregation according to the present invention compared to single rate aggregation is that all packets can be transmitted at a data rate that is optimal for the respective receiver and its Quality of Service requirements. With single rate aggregation and the scenario in FIG. 1A the whole packet would have to be transmitted at 6 Mbps, because node 114 is not able to receive data from the respective sender at higher data rates. With the present invention packets in FIG. 1A can be transmitted at 6 Mbps, 54 Mbps and 108 Mbps within the same aggregate.

Each node 112 113 114 within the WLAN 100 shown in FIG. 1A may include a system including an architecture that is illustrated in FIG. 1B. As shown, each node 112 113 114 may include an antenna 156 coupled to a receiver 152 that communicates over the wireless medium 160. The nodes 112 113 114 each further comprise a processor 153 and a PPDU Processing Module 154. For example, in a node the processor 153 is configured to receive from the receiver 152 a frame including a PPDU and to process the PPDU using the PPDU Processing Module 154 to determine, e.g., whether packets are waiting to be transmitted to the node and arranges to be awake to receive these packets and store them in at least one buffer which is part of a memory 158. The memory, in addition, stores information concerning the transmission types and numbers of packets to be received from each sender node. In a node 112 113 114, the processor 153 is further configured to use the PPDU Processing Module 154 to send aggregated/packet bursts.

FIG. 2 illustrates a potential PPDU format for 802.11n as discussed by the consortium TGn Sync. Note that the PPDU format has been chosen for illustrative purposes and that the present invention is not restricted to the specific PPDU format of TGn Sync. In FIG. 2 the Legacy Short Training Field (L-STF) 201, Legacy Long Training Field (L-LTF) 202 and Legacy Signal Field (L-SIG) 203 are included for backwards compatibility with legacy 802.11 devices. In case of a 40 MHz transmission the fields are transmitted with a bandwidth of 20 MHz on both halves of the 40 MHz channel, whereby the fields on one half are phase rotated with respect to the other half. The legacy field is followed by a High Throughput Signal Field (HT-SIG) 204, which is also transmitted on both 20 MHz channels in case of a 40 MHz transmission. The sub-fields of the HT-SIG are also illustrated in FIG. 2. The HT-SIG 204 is important for the present invention, because it is modified in most embodiments of this invention to include the multiple MCS and receiver aggregation information. After the HT-SIG a High Throughput Short Training Field (HT-STF) 205 is transmitted (in 40 MHz mode in case of a 40 MHz transmission) for the purpose of Automatic Gain Control (AGC). This field is followed by a number of High Throughput Long Training Fields (HT-LTF) 206 that are used for Multiple Input Multiple Output (MIMO) channel estimation as well as frequency or time synchronization. The number of HT-LTFs is equal to the number of antennas, respectively transmit streams. The different fields are not described in detail in this invention and only serve as an example of what the structure of the PHY header might look like. The PHY header is followed by the PSDU-DATA 207, which contains the Protocol Data Units of the Medium Access Control (MAC) layer called MPDUs (MAC Protocol Data Units).

FIG. 3 illustrates how the Multiple MCS and Receiver Aggregation (MMRA) information could be included in the exemplary PPDU structure of FIG. 2. The HT-SIG could be extended to include an MMRA part with all the relevant MA information. The infonmation in this MMRA part is one of the key features of the present invention. However, the location of the MMRA part/information can vary according to the present invention. This is illustrated in some of the following embodiments of the invention. In FIG. 3 the MMRA part is part of the PHY header of the PPDU. It could also be transmitted on MAC level as an MPDU in the PSDU-DATA part of the PPDU. Another alternative embodiment is the transmission of the MMRA part as a separate PPDU in case of a burst or aggregate of several PPDUs. In these latter two cases, the MMRA part in the PHY header would have zero length, respectively would not be present.

In FIG. 3 the HT-SIG also contains an additional bit to signal the MMRA type of data transmission. If the MMRA part is transmitted at a variable MCS (which could e.g. be the most robust MCS of all MCSs in the PSDU-DATA part of the PPDU), the HT-SIG also contains the MCS code of the MMRA part, as shown in FIG. 3. The MCS code does not have to be transmitted in an additional field of the HT-SIG, because an existing RATE field could be used for that purpose.

Independently whether the MMRA part is transmitted in the PHY header, MAC header, as MPDU or as PPDU, it is essential that the MMRA part is transmitted before the rest of the PSDU-DATA part, respectively the other PPDUs. The reason is that, according to the present invention, the MMRA part serves the purpose of allowing for efficient power saving at the intended receivers as well as at all other receivers of the PPDU(s). It is also possible to put part of the MMRA information in the MMRA part in the PHY layer and part of the information in the MAC layer, as will be shown in the different aspects of the invention. The two different parts of the MMRA information will not be denoted PHY-part and MAC-part but MMRA part of the HT-SIG for the PHY and MRAD for the MAC. MRAD stands for Multiple Receiver Aggregate Descriptor and is a term defined by TGn Sync. We are re-using this name for our purposes.

In order to enable the power saving scheme, the MMRA information includes the station identifiers (STA-IDs) of the intended receivers of the PPDU(s) as well as the position of the MPDUs in the PSDU-DATA part in case of a single PPDU, respectively the position of the PPDUs in case of an aggregate of PPDUs. By decoding the MMRA part, the receivers can deduce whether DATA is included for them in the PSDU-DATA part in case of a single PPDU, respectively the following PPDUs in case of an aggregate of PPDUs. If a station is not mentioned as intended receiver of the PPDU(s), it can go into sleep mode for the entire rest of the PPDU(s). If a station is mentioned as intended receiver, the position information allows the receiver to deduce when it has to wake up during the PSDU-DATA part in case of a single PPDU, respectively the following PPDUs in case of an aggregate of PPDUs.

The position can be signaled by giving for a specific receiver the offset of the beginning of the MPDUs or PPDUs intended for this receiver with respect to a pre-defined position. This pre-defined position could e.g. be the beginning of the (first) PPDU or the beginning of the PSDU-DATA part.

An alternative way to signal the positions could be to include the length of the MPDUs or PPDUs intended for a specific receiver. This would give more detailed information to the receiver, because it would know how much data to expect. On the other hand, a station would have to sum up the lengths of all previous length fields to derive the beginning of its MPDUs or PPDUs. In the following we will always refer to length/offset to imply both possible ways of signaling the position information.

Beside the MMRA information, another key feature of the present invention is the inclusion of pre-ambles inside the PSDU-DATA part of a PPDU, which could therefore also be called mid-ambles. The purpose of the mid-ambles is to allow a receiver to re-synchronize with the PPDU and eventually also to re-assess the channel after waking up from sleep-mode during the aggregate. This is required for the power saving scheme of the invention, which allows receivers to go into sleep-mode until the beginning of their MPDUs or the beginning of their MCS aggregate (see below: an MCS aggregate is a group of MPDUs within the PPDU that are transmitted at the same MCS).

The additional pre-ambles are not required in case of an aggregate of PPDUs, as PPDUs already start with pre-ambles. However, in order to save overhead, the PPDU pre-ambles may be omitted for PPDUs inside an aggregate of PPDUs. In this case additional pre-ambles/mid-ambles would again be required at positions inside the aggregate, where a wake-up of the receivers should be possible.

There is a trade-off between power saving efficiency and overhead due to the mid-ambles. The more mid-ambles are inserted, the finer is the granularity of the possible wake-up points and thereby the higher the efficiency of the power saving scheme. On the other hand, the more-midambles the higher is the overhead and the lower the data throughput. According to the present invention, a mid-amble is either inserted whenever the receiver changes or whenever the rate/MCS changes. In most cases, the MPDUs or PPDUs of several receivers will be transmitted at the same MCS. Therefore, inserting a mid-amble whenever the MCS changes, results in less mid-ambles per aggregate but also in a less efficient power saving than by inserting a mid-amble per receiver. Including a mid-amble whenever the MCS changes, can be considered as compromise between power saving efficiency and overhead. With this solution, the scheme can also be beneficial for an aggregate of PPDUs, because the pre-ambles of the PPDUs can be omitted and only included, whenever the MCS changes inside the aggregate of PPDUs.

In some of the following embodiments/aspects a pre-amble/mid-amble is inserted when the rate changes and in others when the receiver changes. In all figures MPDU aggregation is shown, as the use of the scheme with PPDU aggregation would be analogous, with the MMRA part transmitted in a first PPDU.

The structure of the pre-amble/mid-amble depends on whether its purpose is only time and frequency adjustment, rsp. re-synchronization or whether also a new channel estimation is required. In the first case the pre-amble only has to include shorter training fields, whereas in the latter case also long training fields have to be included. In the case of the standard IEEE 802.11n, this may result in a pre-amble in the range of 4 μs to 20 μs depending on the purpose of the pre-amble/mid-amble.

FIG. 4 shows the structure of the MMRA part 405 and PSDU-DATA 455 in the case of the first aspect of the invention for an exemplary group of five devices, two of which are transmitting at Modulation/Coding Scheme 1 (MCS1) , two others at MCS2 and a third one at a different MCS3. It is assumed for simplicity in this example that each device is sending just one MPDU. Transmission of multiple MPDUs per device is obviously possible. The MMRA part starts with a length field 401, as the MMRA part may be of variable length. Furthermore, according to this first aspect the MMRA part e.g. of the HT-SIG contains the following aggregation information for each “j” of the devices (STAs):
Receiver (STAs) identifier (e.g. MAC address or Association identifier) 402.j.1;
MCS of this MPDU 402.j.2; and
PDU Length or Offset (given in number of bytes, symbols or time units) 402.j.3.

Such a set of three fields is called a “tuple” because it is a repeated grouping of the same fields, one for each MPDU. Each of the MPDUs comprises a MAC header and a payload. The Receiver Address (RA) in the MAC header is the same MAC address as the one that may appear in the ‘STA ID’ field 402.j.1 of the MMRA part. The Preambles 415.j following the MPDUs are used by the receiving device to synchronize and demap the following MPDU 425.j at the desired data rate (indicated in the MCS Field of the MMRA part).

With this first aspect of the invention there are multiple tuples that may contain the same STA ID. Multiple tuples having the same STA ID results in a particular device receiving multiple MPDUs in this aggregate PSDU. The MPDUs destined for one device may further be arranged adjacent to each other in order to improve the power-savings at the receiver.

As shown in FIG. 5, a second aspect of the present invention differs from the first aspect of the invention with regard to the function of a tuple. In the third aspect, a tuple in the MMRA part can refer to multiple MPDUs for the same destination device. An additional field 502.i.2 is included in a tuple that indicates the number of MPDUs for the respective destination device. The MPDUs and respective fragments of the tuple may or may not be of same size, as the Length field indicates the total length of all MPDUs for this destination device. If the Offset is used instead of the Length of the MPDUs the beginning or the end of all MPDUs destined for a certain receiver is signaled. The Offset can be given, respectively defined in terms of bytes, symbols or time.

With regard to the above-mentioned fields of the first and second aspects of the present invention, these fields are sufficient for a STA to calculate when it should start receiving data and for how long. One advantage of the present invention is that the STA can decide to execute a power saving scheme when the STA does not have to receive any data.

FIG. 6 shows the sleep-awake periods at the five devices (STA1 to STA6) used as examples in FIG. 4 and FIG. 5 to illustrate the first and second aspects of the invention during the reception of a typical aggregated PPDU with different receivers and the sleep mode of a sixth device STA6, which is not mentioned as receiver in the PPDU. This STA6 can remain in a sleep mode during the whole frame transmission thanks to the MMRA part containing the STA identifiers of the receiving STAs of this PPDU. It can be seen that STA6 remains at a low level (indicating sleep) throughout the PPDU.

The advantages of the first and second aspects include:
1. no Inter Frame Space (IFS) and backoff between MPDUs with different MCS (an IFS may have to be included if the transmit power is changed during the aggregate);
2. efficient power save for STAs;
3. knowledge at the STA that it can receive an MPDU in this aggregated PPDU;
4. MPDUs may be delivered to each STA at a different PHY rate;
5. efficient use of the medium; and
6. no need for MPDU delimiters.

The disadvantages of the second aspect include:
1. PHY needs to have knowledge of device's MAC address (if the MMRA part is transmitted as part of the HT SIG in the PHY header);
2. PHY needs to be aware of MPDU boundaries since aggregation is no longer a pure MAC function; and
3. as many pre-ambles/mid-ambles are needed as there are MPDUs.

In FIG. 7, an example, including frame formats, is illustrated for the MMRA part and PSDU-DATA of a third aspect of the present invention. Similar to the previous example, five devices are illustrated, two of which are transmitting at MCS1, two others at MCS2 and the third one at a different MCS3. One difference that distinguishes this third aspect of the invention from, for example, the second aspect of the invention, is that MPDUs using the same MCS are grouped. Beside the total length of the MMRA part 701, the following aggregation information is included in the MMRA part for each group of receiving STAs with the same MCS:
MCS for a group of STA with the same MCS (MCS Aggregate) 702.i.1;
Length or offset of all aggregates with the same MCS 702.i.2;
Nr. Receivers (to indicate how big will be the next subfield that contains the STA identifiers of the devices) 702.i.3; and
List of STA identifiers 702.i.j, j≧0. Similar to the previously illustrated example, the PSDU contains all MPDUs (MAC Header+Payload) and attaches to them an MPDU_Delimiter (Length and CRC) in order to separate MPDUs and optionally also to indicate the length of the next MPDU. The MPDU delimiter may, for example, contain the length of the following MPDU, a Cyclic Redundancy Check (CRC) sum as well as a unique pattern (not shown).

In contrast to the previously illustrated aspects of the invention, in the third aspect the pre-amble/mid-amble is only used in order to separate aggregates of different MCSs. Note that an interframe spacing (IFS) can be inserted before the pre-amble/mid-amble in all aspects mentioned for the invention. An interframe space could, e.g., be required if the transmit power is changed inside the aggregate. Two MPDUs at the same rate will be separated just with an MPDU_Delimiter, whereas the next MPDU at a different rate will be preceded by a pre-amble/mid-amble for synchronization and eventually also channel estimation purposes after the sleep-awake phase. The use of an PDU Delimiter between MPDUs of the same rate is not necessarily required and can be considered as an option. The pre-ambles following an aggregate of MPDUs (with the same MCS) may be used by the receiving devices to synchronize and demap the following MPDUs at the desired data rate (indicated in MCS Field of the MMRA part).

FIG. 8 illustrates the MMRA part and PSDU-DATA frame formats of a fourth aspect of the present invention using the previous example of five stations, two of which are transmitting at MCS1, two others at MCS2 and the third one at a different MCS3. The difference to the previous third aspect of the invention is that in the fourth aspect Length or Offsets are not given per MCS aggregate but in a more detailed way per receiving station. As in the third aspect, pre-ambles/mid-ambles are included whenever the MCS changes.

FIG. 9 shows the sleep-awake periods at the five devices (STA1-STA5) during the reception of a typical aggregated PPDU according to the third and fourth aspects of the invention, and the sleep mode of a STA6, which is not listed as receiver. This STA6 can remain in sleep mode during the whole frame transmission thanks to the MMRA part containing the STA identifiers of the receiving STAs of this PPDU. A station which is listed as receiver in the MMRA part can go into sleep mode until the beginning of its MCS aggregate. An MCS aggregate is a group of MPDUs that are transmitted at the same MCS. This may mean that a station will have to wake up some time before its own MPDUs will be received. However, this is necessary, because the station has to wake up before the pre-amble/mi-amble that is preceding its MCS aggregate.

The advantages of the third and fourth aspects include:
1. no IFS (in case of constant power) and no backoff between MSDUs with different MCS;
2. efficient power save for STAs;
3. knowledge at the STA that it can receive an MPDU in this PPDU;
4. MPDUs may be delivered to each STA at a different PHY rate;
5. efficient use of the medium; and
6. fewer number of pre-ambles/mid-ambles are needed to separate MPDUs with different data rates.

The disadvantages of the third aspect include:
1. PHY needs to have knowledge of device's MAC address (if MMRA part is transmitted as part of the HT SIG of the PHY header);
2. PHY needs to be aware of different data-rate aggregate boundaries since aggregation is no longer a pure MAC function;
3. as many pre-ambles/mid-ambles are needed as there are MCS aggregates; and
4. less power save efficient than the first and second aspect.

In the case of the first four aspects of the invention the MMRA part contained all the MMRA information and was included either as part of the PHY header in case of a single PPDU or inside a separate PPDU for the case of a burst of PPDUs. However, the MMRA information could also be split up between PHY and MAC layer, as mentioned before. FIG. 10 illustrates the MMRA part and PSDU-DATA frame formats of a fifth aspect of the present invention, in which the MMRA information is split up between PHY and MAC layer. We are using again the previous example of five devices, two of which are transmitting at MCS1, two others at MCS2 and the third one at a different MCS3. In this case, the MMRA part that is part of the HT-SIG in the PHY layer contains, beside its own total length 1001, only such information that is required by the PHY layer in order to decode the packet, which is for each MCS aggregate “i”:
MCS for this group of STAs with the same MSC (MCS Aggregate) 1002.i.1; and
Length or Offset of the MCS aggregate “i” 1002.i.2.

As shown in FIG. 10 the detailed information about the receivers is not contained in the MMRA part but is contained inside the PSDU DATA in an additional MPDU named MRAD (Multiple Receiver Aggregation Descriptor) in accordance with the nomenclature of the TG Sync specification. This MPDU contains the STA IDs like e.g. the MAC Addresses (or compressed versions) of all stations, whose MPDUs are included in the following MCS Aggregate. If a short STA ID like e.g. the association identifier is used, the Basic Service Set Identifier (BSS-ID) may also be included in the MRAD. Similar to the third and fourth aspect of the invention, a pre-amble/mid-amble is used to separate aggregates of different MCS.

Optionally, the MRAD can also contain the number of MPDUs for this MAC address and/or the length or offset of all MPDUs intended for the respective receiver. This latter optional information is useful in order to let the intended receivers only wake up when their own MPDUs are transmitted. There are as many MRAD MPDUs as MCS groups.

FIG. 11 shows the sleep-awake periods at the five devices (STA1-STA5) during the reception of a typical aggregated PPDU according to the fifth aspect of the invention, and the sleep mode of a STA6, which is not listed as receiver. In contrast to the previously discussed aspects of the invention, STA6 has to wake up at the beginning of each MCS aggregate 1101, synchronize with the pre-amble/mid-amble and decode the MRAD MPDU, in order to check whether its ID is mentioned as a receiver. Only if the STA is not listed as receiver can it fall back into sleep mode.

The advantages of the fifth aspect include:
1. no IFS (in case of constant power) and backoff between MSDUs with different MCS;
2. efficient power save for STAs;
3. knowledge at the STA that it can receive an MPDU in this Super PPDU;
4. MSDUs may be delivered to each STA at a different PHY rate;
5. efficient use of the medium;
6. fewer number of pre-ambles/mid-ambles are needed to separate MPDUSs with different data rates;
7. no need to send all MAC Addresses in HT-SG2; and
8. less PHY overhead

The disadvantages of the third aspect include:
1. PHY needs to be aware of different data-rate aggregate boundaries since aggregation is no longer a pure MAC function;
2. as many pre-ambles/mid-ambles are needed as there are aggregates;
3. less power save efficient than the first and second aspects; and
4. power saving is not optimal for devices not involved in the aggregates.

FIG. 12 illustrates a modification of the previous aspect of the invention. In the sixth aspect of the invention the detailed information about the receivers is again contained in the MMRA part, whereas the PSDU-DATA frame format of the fifth aspect of the invention is kept. By this way, the sixth aspect of the invention has exactly the same sleep-awake periods like in FIG. 11, but a STA6, which is not listed as receiver, can remain in sleep mode during the whole frame transmission thanks to the MMRA part containing the STA identifiers of the receiving STAs of this PSDU.

FIG. 13 describes a seventh aspect of the invention, which differs from the fifth aspect in FIG. 10 in the way that the MRAD information is not included in several MRADs at the beginning of each MCS Aggregate but is instead combined into a Super-MRAD 1309. This Super-MRAD could e.g. be a separate MPDU or PPDU that contains the number of receivers of this aggregate 1309.1 as well as the STA identifiers (like e.g. MAC addresses) 1309.2 of each station, for which MPDUs or PPDUs are included in the aggregate. Optionally, the MRAD can also contain the length or offset 1309.3 of all MPDUs or PPDUs intended for the respective address. This information is useful to let the intended receivers only wake up at the beginning of the sub-aggregate in which their own MPDUs or PPDUs are transmitted. For this purpose a pre-ambles/mid-ambles are again used to separate aggregates of different MCS.

FIG. 14 illustrates an eighth aspect of the invention, in which the Super-MRAD not only comprises the STA identifiers along with the offset or length of the respective MPDUs or PPDUs but also the information regarding the Modulation and Coding Scheme (MCS). This aspect can be considered as the extreme solution where all information is included on MAC level and the opposite of the solutions where all information is included in the PHY headers.

FIG. 15 shows the sleep-awake periods at the five stations (STA1-STA5) during the reception of a typical aggregated PSDU according to the seventh and eight aspects of the invention, and the sleep mode of a STA6, which is not listed as a receiver. These two solutions solved the problem that occurred in the fifth aspect of the invention, where STA6 had to wake up at the beginning of each MCS aggregate. In this case, STA6 can go into sleep mode for the remainder of the PPDU after the Super MRAD, because the Super MRAD contains the STA identifiers of the receiving STAs of this PPDU.

In FIG. 16 the MMRA part and PSDU DATA frame formats are shown to illustrate a ninth aspect of the present invention using the previously allotted number of five devices, two of which are transmitting at MCS1, two others at MCS2 and the third one at a different MCS3.
The detailed information about the receivers is contained in the PSDU-DATA in an additional Super-MRAD MPDU 1609. This Super-MRAD MPDU contains:
Number of receivers 1609.1;
MAC addresses of receivers of this MSC 1609.2; and
after each receiver MAC address: length or offset 1609.3 of the MPDUs for the respective receiver.

In contrast to the previously illustrated aspects of the invention, neither MPDUs nor MCS aggregates are separated by preambles. Two different situations depending on the hardware capabilities can occur: Either MPDU delimiters are sufficient to synchronize to an MCS aggregate after waking up or no sleeping is possible during the entire PPDU. In order to provide the necessary length information for those devices that are capable of making use of it, MCS and length or offset can be included in the MMRA part for each MCS “i”:
MCS for a group of STA with the same MCS (MCS Aggregate) 1602.i.1
Length or Offset of the respective MCS Aggregatel 6o2.i.2

If this information is not included in the MMRA part the Super-MRAD MPDUs have to include MCS code and as many Super-MRADs as different MCSs in the PPDU have to be included. However, it is assumed here that the information is included in the MMRA part field.

FIG. 17 illustrates the sleep-awake periods at the five stations (STA1-STA5) during the reception of a typical aggregated PPDU according to the ninth aspect of the invention, and the sleep mode of a STA6, which is not listed as receiver. In this figure it is assumed that MPDU delimiters are sufficient to synchronize to an MCS aggregate after waking up. However, it is probable that no re-synchronization is possible and that no power saving is possible with the ninth aspect due to the lack of pre-ambles/mid-ambles.

Various modifications can be made to the present invention that do not depart from the spirit of the invention and the scope of the appended claims. For example, the Superframe having a plurality of aggregated packets could have different arrangements of the header than shown, according to need or preference. Aggregation information could be included on physical layer level (in the PHY header) or on MAC level (e.g. in a separate MPDU) or within a separate PPDU. Both MPDU and PPDU aggregation are also possible with the present invention. Any variation of the presented aspects lies therefore within the spirit of this invention. Aggregation information could be included on physical layer level (in the PHY header) or on MAC level (e.g. in a separate MPDU) or within a separate PPDU. Both MPDU and PPDU aggregation are possible with the present invention. Any variation of the presented aspects lies therefore within the spirit of this invention. The systems can use many different types of nodes, and the transmission can be wired or wireless. Protocols other than 802.11 can also be used, so long as they are adapted to accept packet aggregation.

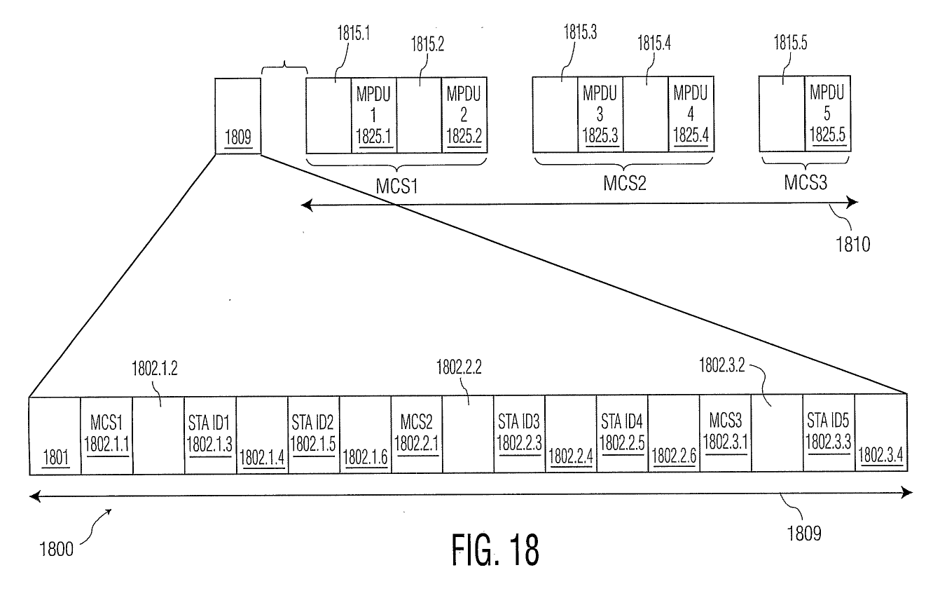

FIG. 18 illustrates how the previous embodiments have to be interpreted, if the different MPDUs are not sent within a single PPDU but e.g. as a burst of multiple MPDUs or PPDUs. The basic ideas still apply. Each PPDU has its own preamble, however this could be changed in some of the embodiments in order to save overhead and to include preambles only between PPDUs of different MCSs. In FIG. 19 some parts of a PPDU like e.g. the PLCP header are not shown explicitly in order to be able to use the same figure to illustrate aggregation of a burst of MPDUs or PPDUs. It is also illustrated in FIG. 18 that interframe spaces can be inserted within an aggregate/burst without changing the basic structure of the embodiments. Interframe spaces could, e.g., be inserted in case of power level changes. Finally it is stressed that the aggregation scheme of the present invention may apply to fragmented or non-fragmented MAC Service Data Units (MSDUs).

While the preferred embodiments of the present invention have been illustrated and described, it will be understood by those skilled in the art that as pointed out above the various formats, e.g., for PPDU and MPDU, and device architecture and methods as described herein are illustrative and various changes and modifications may be made and equivalents may be substituted for elements thereof without departing from the true scope of the present invention. In addition, many modifications may be made to adapt the teachings of the present invention to a particular situation without departing from its central scope. Therefore, it is intended that the present invention not be limited to the particular embodiments disclosed as the best mode contemplated for carrying out the present invention, but that the present invention include all embodiments falling with the scope of the appended claims.

What is claimed is:

1. A method of aggregated transmission of a plurality of Medium Access Control (MAC) Protocol Data Units (MPDUs) (425i), comprising the steps of:
aggregating said plurality of MPDUs into an aggregate/packet burst;
formatting the aggregate/packet burst by performing the substeps of:
a. including at least one of a pre-, rsp. mid-amble (415.i) at least one of in-between an MPDU of said plurality and a group of multiple MPDUs of said plurality, and
b. at the beginning of the aggregate/packet burst, including information comprising data to allow the at least one receiver device to deduce the position of the at least one MPDU and the group of multiple MPDUs in the aggregate/packet burst;
transmitting the formatted aggregate/packet burst to one of at least one receiver device or group of receiver devices using at least one Physical (PHY) rate; and
at least one receiver device or at least one group of receiver devices going into sleep mode and waking-up during the aggregate/packet burst.

2. The method of claim 1, wherein the formatting step further comprises the substep of:
a. formatting said MPDUs 425.i within a single PLCP (Physical Layer Convergence Protocol) Protocol Packet Data Unit (PPDU) (400).

3. The method of claim 1, wherein the formatting step further comprises the substep of:
a. formatting said MPDUs within a plurality of PLCP (Physical Layer Convergence Protocol) Protocol Data Units (PPDUs) having at least one MPDU per PPDU (215) as a burst or aggregate of PPDUs.

4. The method of claim 1, wherein the formatting step further comprises the substep of:
a. formatting the information within a separate MPDU 425.1 before said plurality of MDPUs.

5. The method of claim 2, wherein the formatting step further comprises the substep of:
a. formatting the information within a Medium Access Control (MAC) header of the PPDU or a separate MPDU inside the PPDU.

6. The method of claim 2, wherein the formatting step further comprises the substep of:
a. formatting the information within a PHY header of the PPDU.

7. The method of claim 2, wherein the formatting step further comprises the substep of:
a. formatting part of said information within a PHY header and the remaining part of said information within one of a MAC header or a separate MPDU inside the PPDU.

8. The method of claim 2, wherein the formatting step further comprises the substep of:
a. including at least one bit (308) that identifies the PPDU as containing an aggregation of packets.

9. The method of claim 1, wherein said information further comprises, for each of the at least one receiver device or a group of receiver devices, at least:
an identifier of the at least one receiver device or group of receiver devices (402.i.1);
a Modulation and Coding Scheme (MCS) (402.i.2) of at least one of a particular MPDU or a group of MPDUs or PPDUs; and
a Length or Offset of at least a PPDU or a group of PPDUs (402.i.3).

10. The method according to claim 9, wherein said information further comprises a Basic Service Set ID (BSSID).

11. The method of claim 9, wherein the identifier is a MAC address.

12. The method of claim 9, wherein the information further comprises at least one of a plurality of MPDUs and a plurality of PPDUs for a same receiver.

13. The method of claim 9, wherein the information further comprises at least one group selected from the group consisting of a plurality of MPDUs and a plurality of PPDUs, and further comprising the step of transmitting the at least one group at the same MCS.

14. The method of claim 1, wherein the including substep a. further comprises the substep of:
a.1 including said pre-, rsp. mid-amble (415.i) between a plurality of MPDUs (425.i) that are intended for different receivers.

15. The method of claim 1, wherein the including substep a. further comprises the substep of:
a.1 including said pre-, rsp. mid-ambles (715.i) between a plurality of groups of MPDUs (756) that are transmitted at different MCS (702.i.1).

16. The method of claim 1, wherein the including substep a. further comprises the substep of:
a.1 including said pre-, rsp. mid-ambles and an interframe-space between a plurality of groups of MPDUs that are transmitted at different power levels.

17. The method of claim 1, further comprising the step of the at least one receiver of the aggregate sending a response frame after the receipt of the aggregate.

18. The method of claim 17, wherein the sending step further comprises the step of the at least one receiver sending the response frame in an order that has been scheduled by a sender of the aggregate.

19. The method of claim 3, further comprising the steps of the at least one receiver interrupting the aggregate/burst, and thereafter sending a response frame.

20. The method of claim 2, wherein the formatting step further comprises the step of formatting the PPDU to include:
one of a High Throughput Signal Field (HT-SIG) (304) and a separate PPDU having an MMRA (304.2) (405) part including a total length (401) of a following at least one tuple (402.i.1-3); and
at least one tuple (402.i.1-3) comprising the following aggregation information for each of a plurality of respective receiver devices:
i. an identifier of each respective receiver device (402.i.1),
ii. an MCS (402.i.2) at which at least one MPDU (425.i) or group of MPDUs destined for each respective receiver device is transmitted, and
iii. a length or offset (402.i.3) of the at least one MPDU or group of MPDUs destined for the respective receiver device.

21. The method of claim 2, wherein the formatting step further comprises the step of formatting the PPDU to include:
one of a High Throughput Signal Field (HT-SIG) (304) and a separate PPDU having an MMRA (304.2) (505) part including a total length (501) of a following at least one tuple (502.i.1-4); and
at least one tuple (502.i.1-4) comprising the following aggregation information for each of a plurality of respective receiver devices:
i. an identifier of each respective receiver device (502.i.1),
ii. a number (502.i.2) of receivers consisting of at least one of an MPDU or a group of MPDUs destined for each respective receiver device,
iii. an MCS (502.i.3) at which the at least one MPDU or group of MPDUs destined for each respective receiver device is transmitted, and
iv. a length or offset (502.i.4) of the at least one MPDU or group of MPDUs destined for the respective receiver device.

22. The method of claim 2, wherein the formatting step further comprises the step of:
a. formatting the PPDU to include:
(1) one of a High Throughput Signal Field (HT-SIG) (304) and a separate PPDU having an MMRA (705) part comprising a total length (701) of a following at least one tuple (702.i.1-5); and
(2) at least one tuple (702.i.1-5) comprising the following aggregation information for one of at least one receiver device and at least one group comprising a plurality of receiver devices for which at least one MPDU is transmitted at a same MCS:
i. the MCS (702.i.1) for the at least one of the at least one receiver device and the at least one group of a plurality of receiver devices having the same MCS (MCS Aggregate),
ii. a length or offset (702.i.2) of the at least one MPDU having the same MCS,
iii. a number N (702.i.4) of receivers consisting of the at least one of the at least one receiver device and the at least one group of a plurality of receiver devices for which packets are transmitted at the respective MCS, and
iv. a list of N receiver addresses (702.i.4-N) consisting of at least one of the address of the at least one receiver device and at least one group of a plurality of receiver devices for which packets are transmitted at the respective MCS.

23. The method of claim 2, wherein the formatting step further comprises the step of
a. formatting the PPDU to include:
(1) one of a High Throughput Signal Field (HT-SIG) (304) and a separate PPDU having an MMRA (805) part comprising a total length (801) of the following at least one tuple (802.i.1-N); and
(2) at least one tuple (802.i.1-N) comprising the following aggregation information for one of at least one receiver device and at least one group of a plurality of receiver devices for which at least one MPDU is transmitted at a same MCS:
i. the MCS (802.i.1) for the at least one receiver device and group of a plurality of receiver devices having the same MCS (MCS Aggregate),
ii. a number N (802.i.2) of receivers consisting of the at least one of the at least one receiver device and the at least one group of a plurality of receiver devices for which packets are transmitted at the respective MCS, and
iii. a list of N receiver addresses (802.i.3-N) consisting of at least one of the address of the at least one receiver device and at least one group of a plurality of receiver devices for which packets are transmitted at the respective MCS, each entry comprising a receiver address and a length or offset of the at least one MPDUs intended for this receiver.

24. The method of claim 2, wherein the formatting step further comprises the step of:
a. including one of a High Throughput Signal Field (HT-SIG) (304) and a separate PPDU having an MMRA part (1005) comprising a total length (1001) of the following at least one tuple (1002.i.1-2) and comprising, for each group of a plurality of receiver devices (MCS aggregate) of MPDUs that are transmitted at a same MCS, a tuple including:
i. the MCS (1002.i.1) for the group of a plurality of receiver devices; and
ii. a length or offset (1002.i.2) of all MDPUs intended for the group.

25. The method of claim 24, wherein the formatting step further comprises the steps of:
a. including a Multiple Receiver Aggregation Descriptor (MRAD) (1008.1) as part of a first MAC header in the PPDU or as a separate MPDU in a data part of the PPDU.

26. The method of claim 2, wherein the formatting step further comprises the steps of:
a. including a Multiple Receiver Aggregation Descriptor (MRAD) (1208.1) as part of a first MAC header in the PPDU or as a separate MPDU in a data part of the PPDU; and
b. including aggregation information comprising a device identifier (1201.i.4- . . . ) for each of a plurality of receiver devices having at least one receiver device thereof that transmits at a different modulation/coding scheme (MCS).

27. The method of claim 3, wherein the formatting step further comprising the steps of:
a. including a Multiple Receiver Aggregation Descriptor (MRAD) (1208.1) as a separate PPDU at the beginning of a burst/aggregate; and
b. including aggregation information comprising a device identifier (1201.i.4- . . . ) for each of a plurality of respective receiver devices having at least one receiver device thereof that transmits at a different modulation/coding scheme (MCS).

28. The method of claim 1, wherein the formatting step further comprises the step of:
a. including a part or all of said information in a Super-Multiple Receiver Aggregation Descriptor (MRAD) (1309) comprising one of its own MPDU and PPDU as part of the aggregate/burst, said information further including:
i. a number N of receivers (1309.1);
ii. for each receiver, including-
(a) a device identifier (1309.2.1-N), and
(b) one of the length and offset (1309.3.1-N) of the MPDUs intended for the receiver.

29. The method of claim 1, wherein the formatting step further comprises the step of:
a. including at least a part of said information in a Super-Multiple Receiver Aggregation Descriptor (MRAD) (1409) comprising one of its own MPDU and PPDU as part of the aggregate/burst, said information further including for each group of MPDUs or PPDUs transmitted at the same MCS, information selected from the group consisting of:
i. an MCS (1402.i.1) of the respective group of MDPUs or PPDUs;
ii. a number N of receivers within the group of MDPUs or PPDUs;
iii. for each of the receivers (1402.i.2) in the group of MDPUs or PPDUs: a device identifier and the length or offset of the MPDUs intended for the respective receiver.

30. The method of claim 1, wherein the going into sleep mode step further comprises the step of the at least one receiver device or at least one group of receiver devices of the aggregate performing the steps of:
deducing the beginning of the plurality of MPDUs that are intended for the at least one receiver device or the at least one group of receiver devices from the included information; and
falling into sleep mode and waking up prior to the latest pre-, rsp. mid-amble that is transmitted before the beginning of the plurality of MPDUs that are intended for the at least one receiver device or the at least one group of receiver devices.

31. A system for multi-rate aggregation of packets, comprising:
a plurality of nodes 112, 113, 114;
a device 115;
wherein at least one of the plurality of nodes is adapted for receiving a PPDU comprising an aggregation of multi-rate packets or a burst of multi-rate packets.

32. The system of claim 31, wherein one node 114 of the plurality of nodes 112, 113, 114 has a different PHY rate of transmission.

33. The system of claim 32, wherein a plurality of the plurality of nodes 112, 113, 114 are adapted for receiving the PPDU comprising an aggregation of packets or the burst of packets at different transmission rates 127, 128, 129.

34. The system of claim 32, wherein an arrangement of aggregated packets is grouped to provide a power savings for the plurality of nodes for transmission and receipt of the superframe.

35. The system of claim 32, wherein the plurality of nodes comprises devices (112 113 114) and an Access Point (115) operating under IEEE 802.11 that are adapted to send/receive a superframe or a burst of packets comprising a plurality of packets.

36. The system of claim 31, wherein:
a pre-, rsp. mid-amble is transmitted in-between each or between multiples of MPDUs allowing receiving devices to go into sleep mode and wake-up during the aggregate;
information is transmitted at the beginning of the aggregate, which allows devices to deduce the position of MPDUs or multiples of MPDUs in the aggregate.

37. The system of claim 36, wherein a receiver of the aggregate deduces the beginning of the MPDUs that are intended for it from said information in the aggregate, falls into sleep mode and wakes up prior to the latest pre-, rsp. mid-amble that is transmitted before the beginning of its MPDUs.

38. The system of claim 37, wherein pre-, rsp. mid-ambles are at least used to re-synchronize on physical layer and re-estimate the channel after waking up from sleep mode.

39. A device that manages aggregated transmission of a plurality of Medium Access Control (MAC) Protocol Data Units (MPDUs) packets, comprising:
an antenna (157) for sending and receiving aggregate/packet burst transmissions;
a receiver (152) coupled to the antenna (157) to receive aggregate/packet bursts (1800) transmitted over a wireless medium (160);
a transmitter (156) coupled to the antenna (157) to transmit aggregate/packet bursts (1800) over the wireless medium (160) to a receiver selected from the group consisting of at least one receiver or at least one group of a plurality of receivers using at least one physical (PHY) rate;
a PPDU processing module (154) to process sent and received aggregate/packet bursts (1800) to respectively position or deduce the position of the at least one of said plurality of MPDUs therein;
a processor (153) coupled to the receiver, transmitter, PPDU processing module to aggregate and disaggregate data respectively into and from aggregate/packet bursts including the at least one of said plurality of MPDUs that includes:
i. at least one of a pre-,rsp. mid-amble (415.i) in-between groups of at least one of said plurality of MPDUs, and
ii. at the beginning of an aggregate/packet burst, information that allows at least one receiver or at least one group of receivers to deduce the position of the at least one of said plurality of MPDUs;
wherein, the at least one receiver or at least one group of receivers goes into sleep mode and wakes up during the aggregate/packet burst.

40. The device of claim 39, wherein the PPDU processing module is further configured to format said MPDUs within a single PLCP (Physical Layer Convergence Protocol) Protocol Packet Data Unit (PPDU).

41. The device of claim 39, wherein:
the PPDU processing module is further configured to format said MPDUs with a plurality of PLCP (Physical Layer Convergence Protocol) Protocol Packet Data Units (PPDUs) having at least one MPDU per PPDU as an aggregate/packet burst;
and the processing unit is further configured to address the aggregate/packet burst to one or several receivers and direct the transmitter 156 to transmit the aggregate/packet burst at one or several different Physical (PHY) rates.
